(19) United States
(12) Patent Application Publication
(10) Pub. No.: US 2010/0023522 A1
(43) Pub. Date: Jan. 28, 2010

(54) Dynamically controlling permissions

(76) Inventors: George Madathilparambil George, Hyderabad (IN); Nikhil George, Hyderabad (IN)

Correspondence Address: GEORGE MADAT-H-ILPARAMBIL GEORGE, 1208, Block 1, Naren''s SMR Vinay City, Bollaram Road, Miyapur, Hyderabad, 500049, IN

(21) Appl. No.: 12/218,741

(22) Filed: Jul. 18, 2008

(51) Int. Cl. G06F 17/30

(52) U.S. Cl. 707/9; 707/E17.005

(57) ABSTRACT

A high level of computer security can be achieved by controlling read/write/execute access to files, controlling incoming or outgoing network connections, controlling incoming or outgoing network traffic and controlling privileged operations based on states of Application Security Environments and/or based on states of users or groups of users and/or based on states of privilege objects. These states can be controlled dynamically by software or by one or more hardware devices.

### BACKGROUND OF THE INVENTION

This invention relates to changing the protection for files and directories, for incoming and outgoing network connections, for incoming and outgoing network data traffic, for privileged operations and for permission structures dynamically using states.

UNIX operating systems normally use protection based on the user, the group and others. Each file is owned by a user and each user belongs to a user-group. The user and user-group who owns the file can have permissions different from other users. UNIX file system permissions provide different users access to read, write or execute files. Similarly, UNIX file system permissions provide different users access to read, write or search directories.

Newer versions of UNIX and Windows operating systems allow the use of Access Control Lists (ACLs) which allow permissions to be different for each user or user-group. This allows fine grained access control for files and directories as the ACL can be used to assign different permissions for each user or each user-group.

U.S. patent applications Ser. Nos. 11/514807, 11/515619 and 11/519178 show how different user states can be used to control access to regions of disks dynamically.

Application Security Environments are environments in which processes or tasks can be run where privileges of those processes or tasks can be more restricted than the privileges of the users or the user-groups (a user-group is a group of users) who own those processes or tasks. Examples of Application Security Environments are SUN Containers and HPUX Security Containers. U.S. patent applications Ser. Nos. 12/079369, 12/082606 and 12/151853 show how Application Security Environment states can be used to control privileges for Application Security Environments dynamically using Application Security Environment states. Each Application Security Environment is owned either by a user or a user-group.

### BRIEF SUMMARY OF THE INVENTION

A privilege object has one or more states such that these states can be mapped to permissions which processes or tasks have to perform operations on one or more objects. The state of a privilege object can be used to dynamically change permissions of processes or tasks to perform operations on objects such as devices attached to a computer, files, directories, etc. A privilege object can be used to control access to any object in the operating system such as a group of files and directories and/or to control access to devices attached to a computer.

The file or directory permission data structures for each file or each directory can allow different sets of permissions to be configured for different states of the privilege objects and/or for different states of the users/user-groups (a user-group is a group of users) and/or for different states of the Application Security Environments. This will allow the file or directory permissions of some processes/tasks running in an operating system to change dynamically based on:
i. The current state of the Application Security Environment in which that process is running or
ii. The current state of the user/user-group who owns that process or the Application Security Environment in which that process is running or
iii. The current state of a privilege object which represents these files and directories.

In a file system which allows file and/or directory permissions to change dynamically based on the state of a privilege object, when a process/task attempts to perform an operation on a file or a directory, the file system can get the current state of the privilege object if any, which represents the file or directory and the file or directory permissions if any, corresponding to that state of that privilege object for that file or directory and allow or deny the operation based on those file permissions. In a file system which allows file and/or directory permissions to change dynamically based on the state of a user, when a process/task owned by a user attempts to perform an operation on a file or a directory, the file system can get the current state of that user and the file or directory permissions if any, corresponding to that state of that user for that file or directory and allow or deny the operation based on those file or directory permissions. In a file system which allows file or directory permissions to change dynamically based on the state of a user-group, when a process/task owned by a user-group attempts to perform an operation on a file or a directory, the file system can get the current state of that user-group and the file or directory permissions if any, corresponding to the current state of that user-group for that file or directory and allow or deny the operation based on those file or directory permissions. In a file system which allows file or directory permissions to change dynamically based on the Application Security Environment states, when a process/task in an Application Security Environment attempts to perform an operation on a file or a directory, the file system can get the current state of that Application Security Environment and the file or directory permissions if any, corresponding to that Application Security Environment state for that file or directory and allow or deny the operation based on those file or directory permissions.

In a file system which allows the file or directory permissions to change dynamically based on both the Application Security Environment states and the user or user-group states, when a process/task in an Application Security Environment requests a file or directory operation then preferably, the permissions corresponding to the current state of that Application Security Environment if any, are used to determine whether that operation can be allowed to proceed. In a file system which allows the file or directory permissions to change dynamically based on both the Application Security Environment states and the user or user-group states, when a process/task in an Application Security Environment requests a file or directory operation then preferably, the permissions if any, corresponding to the current state of the user/user-group who owns that Application Security Environment are used if there are no permissions configured for the current state of that Application Security Environment. In a file system which allows the file or directory permissions to change dynamically based on the privilege object states, the user/user-group states and the Application Security Environment States, when a process/task in an Application Security Environment requests a file or directory operation then preferably, the permissions corresponding to the current state of the privilege object are used only if there are no permissions configured for the current state of the Application Security Environment in which that process/task is running and if there are no permissions configured for the current state of the user/user-group who owns that process/task.

Similarly, an incoming or outgoing network connection to or from a process/task in an Application Security Environment owned by a user or a user-group can be allowed or blocked based on the current state of that Application Security Environment or the current state of that user or that user-group or the current state of the privilege object that represents that network connection.

### BRIEF DESCRIPTION OF THE SEVERAL VIEWS OF THE DRAWINGS

FIG. 1 illustrates an example for data structures which allow the file permissions to change dynamically based on the privilege object state, the user and/or user-group states and the Application Security Environment States.

FIG. 2 illustrates an example for data structures which allow the file permissions to change dynamically based on the user states and/or the user-group states and the Application Security Environment states.

FIG. 3 illustrates an example for data structures which allow the file permissions to change dynamically based on the privilege object state and the user and/or user-group states.

FIG. 4 illustrates an example for data structures which allow the directory permissions to change dynamically based on the privilege object state and the Application Security Environment States.

FIG. 5 illustrates an example for data structures which allow file permissions to change dynamically based on the user and/or user-group states.

FIG. 6 illustrates an example for data structures which allow file permissions to change dynamically based on the Application Security Environment states.

FIG. 7 illustrates an example for a state machine of a file system module that implements file permissions that dynamically change based on the privilege object state, the user and/or user-group states and the Application Security Environment states.

FIG. 8 illustrates an example of data structures that can be used to control incoming and outgoing network connections based on states.

FIG. 9 illustrates an example of data structures that can be used to control execution of the privileged operations based on states.

### DETAILED DESCRIPTION OF THE INVENTION

An Application Security Environment can support one or more states. We recommend implementations in which each Application Security Environment will always be in one of the states supported by it. A user or a user-group can support one or more states. We recommend implementations in which each user will always be in one of the states supported by that user. We recommend implementations in which each user-group will always be in one of the states supported by that user-group. A privilege object can support one or more states. We recommend implementations in which a privilege object will always be in one of the states supported by it. A configuration software or a hardware device can be used for configuring supported states and changing the state for each Application Security Environment, for each user, for each user-group and for each privilege object.

The use of default user/user-group permissions, default Application Security Environment permissions, user/user-group default state permissions and Application Security Environment default state permissions help in optimizing data structures and reducing the complexity for configuring permissions. Only those users/user-groups, user/user-group states, Application Security Environments and Application Security Environment states for which permissions different from default permissions need to be configured need separate data structures for file or directory permissions.

The privilege object default state file or directory permissions are permissions for that file or directory assigned to the processes when the privilege object is not in any of the privilege object states which are configured for having a different set of permissions. Preferably, the privilege object state file or directory permissions should have lower priority compared to the user/user-group state permissions and the Application Security Environment state permissions. Having lower priority for the privilege object state file or directory permissions implies that the privilege object state file or directory permissions are assigned to a process only when the current state of the user/user-group who owns that process and the current state of the Application Security Environment in which that process is running are not configured to have a different set of permissions for that file or directory. The default user/user-group (the default users and user-groups are the same as Others) file or directory permissions are permissions for that file or directory assigned to the processes which are owned by the users/user-groups when the users/user-groups are in states which are not configured for having a different set of permissions. The user/user-group default state file or directory permissions of a user/user-group are permissions for that file or directory assigned to the processes owned by that user/user-group when that user/user-group is not in any of the user/user-group states which are configured for having a different set of permissions. Preferably, the user/user-group state file or directory permissions have lower priority compared to the Application Security Environment state file or directory permissions. The default Application Security Environment file or directory permissions are permissions for that file or directory assigned to the processes in the Application Security Environments when these Application Security Environments are in states which are not configured for having a different set of permissions. The Application Security Environment default state file or directory permissions of an Application Security Environment are permissions for that file or directory assigned to the processes in that Application Security Environment when that Application Security Environment is not in any of the Application Security Environment states which are configured for having a different set of permissions.

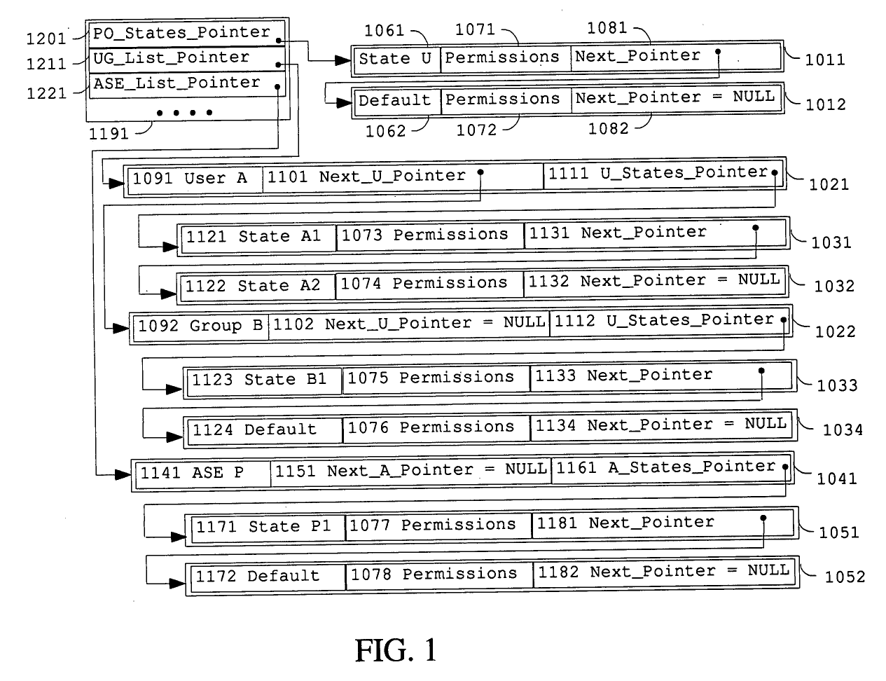

FIG. 1 illustrates an example for data structures which allow the file permissions to change dynamically based on the privilege object state, the user and/or user-group states and the Application Security Environment States. The file structure which identifies a file 1191 contains three address pointers, PO_States_Pointer 1201, UG_List_Pointer 1211 and ASE_List_Pointer 1221. The file system in the example uses a global file system privilege object and hence, the privilege object identifier is not part of each file. The address pointer PO_States_Pointer 1201 points to a list of data structures containing privilege object states and the corresponding permissions for the file identified by the file structure 1191. The address pointer UG_List_Pointer 1211 points to a list of data structures for the users and/or the user-groups. The address pointer ASE_List_Pointer 1221 points to a list of data structures for the Application Security Environments. The first data structure 1011 in the list of data structures for the privilege object states pointed by the address pointer PO_States_Pointer 1201 is a data structure for the privilege object state U. This privilege object state data structure 1011 has fields containing:
i. An privilege object state 1061 which identifies the privilege object state U;
ii. The file permissions 1071 which may be assigned to the processes in the operating system when the privilege object is in the state U depending on the user/user-group entries 1211 and the Application Security Environment entries 1221 in the file configuration and user/user-group/Application Security Environment states of those processes;
iii. An address pointer Next_Pointer 1081 which points to the next data structure in the list of data structures for the privilege object states;
   The address pointer Next_Pointer 1081 points to a data structure 1012 for the default state of the privilege object. The privilege object state data structure 1012 has fields containing:
i. An privilege object state 1062 which identifies the the default state of the privilege object. The default state in this case covers all the states of the privilege object other than the state U 1061.
ii. The file permissions 1072 which may be assigned to the processes in the operating system when the privilege object is not in the state U depending on the user/user-group entries 1211 and the Application Security Environment entries 1221 in the file configuration and user/user-group/Application Security Environment states of those processes;
iii. An address pointer Next_Pointer 1082 which points to the next data structure in the list of data structures for the privilege object states; The address pointer Next_Pointer 1082 contains an invalid pointer (NULL) as the data structure 1012 is the last element in the list.
   The first data structure 1021 in the list of data structures for users/user-groups pointed by the address pointer UG_List_Pointer 1211 is a data structure for the user A. This user/user-group data structure 1021 has fields containing:
i. A user identifier 1091 which identifies the user A;
ii. An address pointer Next_U_Pointer 1101 which points to the next user data structure in the list of user data structures;
iii. An address pointer U_States_Pointer 1111 which points to a list of data structures for user states of the user A and the corresponding permissions for the file identified by the file structure 1191.
   The first data structure 1031 in the list of data structures for the user/user-group states pointed by the address pointer U_States_Pointer 1111 is for the state Al of the User A. This user/user-group-state data structure 1031 has fields containing:
i. A user/user-group state 1121 which identifies the user state A1;
ii. The file permissions 1073 which may be assigned to the processes owned by the user A when the user A is in the state A1 depending on the Application Security Environment entries 1221 in the file configuration and the Application Security Environment states of those processes;
iii. An address pointer Next_Pointer 1131 which points to the next user/user-group state data structure in the list.
   The next data structure 1032 in the list of data structures for user/user-group states pointed by the address pointer Next_Pointer 1131 is for the state A2 of the user A. This user/user-group state data structure 1032 has fields containing:
i. A user/user-group state 1122 which identifies the user state A2;
ii. The file permissions 1074 which may be assigned to the processes owned by the user A when the user A is in the state A2 depending on the Application Security Environment entries 1221 in the file configuration and the Application Security Environment states of those processes;
iii. An address pointer Next_Pointer 1132 which points to the next user/user-group state data structure in the list. The data structure corresponding to the state A2 is the last data structure in the list and hence, the address pointer Next_Pointer 1132 contains an invalid pointer (NULL) value.
   The second data structure 1022 in the list of data structures for users/user-groups pointed by the address pointer Next_U_Pointer 1101 is a data structure for the user-group B. This user/user-group data structure 1022 has fields containing:
i. A user/user-group identifier 1092 which identifies the user-group B;
ii. An address pointer Next_U_Pointer 1102 which points to the next user/user-group data structure in the list of user/user-group data structures; The address pointer Next_U_Pointer 1102 contains an invalid pointer (NULL) value as the data structure corresponding to the group B is the last data structure in the list;
iii. An address pointer U_States_Pointer 1112 which points to a list of data structures for states of the group B and the corresponding permissions for the file identified by the file structure 1191.
   The first data structure 1033 in the list of data structures for user/user-group states pointed by the address pointer U_States_Pointer 1112 is for the state B1 of the user B. This user/user-group state data structure 1033 has fields containing:
i. A user/user-group state 1123 which identifies the user-group state B1;
ii. The file permissions 1075 which may be assigned to the processes owned by the group B when the group B is in the state B1 depending on the Application Security Environment entries 1221 in the file configuration and the Application Security Environment states of those processes;
iii. An address pointer Next_Pointer 1133 which points to the next user/user-group state data structure in the list.
   The second data structure 1034 in the list of data structures for user/user-group states pointed by the address pointer Next_pointer 1133 is for the default state of the user B. This user/group state data structure 1034 has fields containing:
i. A user/user-group state 1124 which identifies the default state; The default state in this case covers all the states of the user B other than the state B1 1123;
ii. The file permissions 1076 which are assigned to the processes owned by the group B when the group B is not in the state B1 depending on the Application Security Environment entries 1221 in the file configuration and the Application Security Environment states of those processes;
iii. An address pointer Next_Pointer 1134 which points to the next user/user-group state data structure in the list; As the data structure corresponding to the default state is the last data structure in the list, the address pointer Next_Pointer 1134 contains an invalid pointer (NULL) value.
   The first data structure 1041 in the list of data structures for Application Security Environments pointed by the address pointer ASE_List_Pointer 1221 is a data structure for the Application Security Environment P. This Application Security Environment data structure 1041 has fields containing:
i. An Application Security Environment identifier 1141 which identifies the Application Security Environment P;
ii. An address pointer Next_A_Pointer 1151 which points to the next Application Security Environment data structure in the list of the Application Security Environment data structures; The data structure corresponding to the Application Security Environment P is the last data structure in the list and hence, the address pointer Next_A_Pointer 1151 contains an invalid pointer (NULL) value.
iii. An address pointer A_States_Pointer 1161 which points to a list of data structures for Application Security Environment states of the Application Security Environment P and the corresponding permissions for the file identified by the file structure 1191.
   The first data structure 1051 in the list of data structures for Application Security Environment states pointed by the address pointer A_States_Pointer 1161 is for the state P1 of the Application Security Environment P. This Application Security Environment state data structure 1051 has fields containing:
i. An Application Security Environment state 1171 which identifies the Application Security Environment state P1;
ii. The file permissions 1077 which are assigned to the processes in the Application Security Environment P when the Application Security Environment P is in the state P1;
iii. An address pointer Next_Pointer 1181 which points to the next Application Security Environment state data structure in the list.
   The next data structure 1052 in the list of data structures for Application Security Environment states pointed by the address pointer Next_Pointer 1181 is the data structure for the default state 1172 of the Application Security Environment P. The default state in this case includes all the states of the Application Security Environment P other than the state P1 1171. This Application Security Environment state data structure 1052 has fields containing:
i. An Application Security Environment state 1172 which identifies the default state of the Application Security Environment P;
ii. The file permissions 1078 which are assigned to the processes owned by the Application Security Environment P when the Application Security Environment P is not in the state P1;
iii. An address pointer Next_Pointer 1182 which points to the next Application Security Environment state data structure in the list. The data structure corresponding to the default state is the last data structure in the list and hence, the address pointer Next_Pointer 1182 contains an invalid pointer (NULL) value.

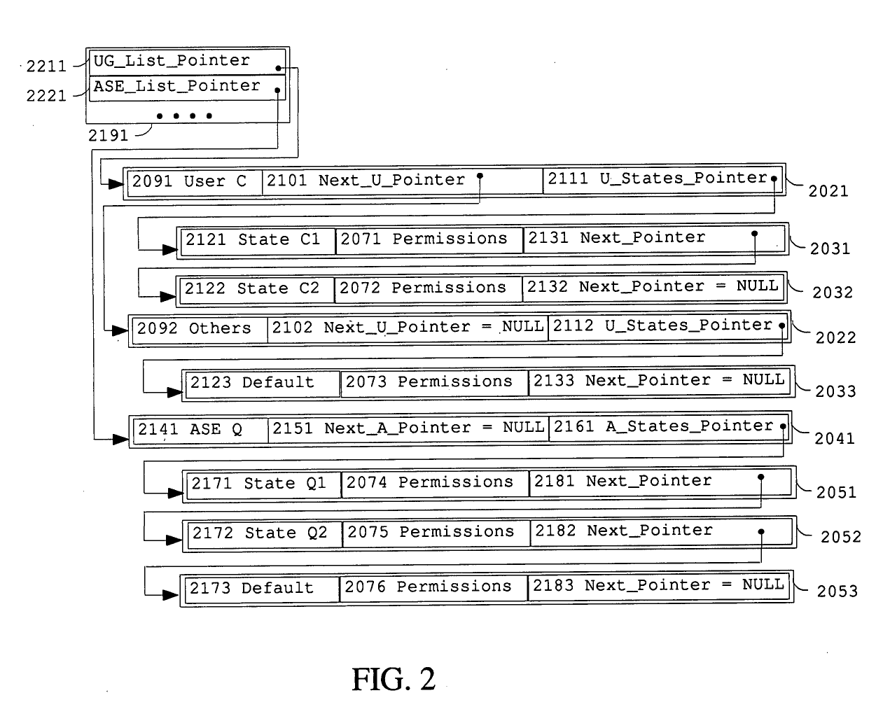

FIG. 2 illustrates an example for data structures which allow the file permissions to change dynamically based on the user and/or user-group states and the Application Security Environment states. The file structure 2191 contains two address pointers, UG_List_Pointer 2211 and ASE_List_Pointer 2221. The UG_List_Pointer 2211 points to a list of data structures for users and/or user-groups. The ASE_List_Pointer 2221 points to a list of data structures for Application Security Environments. The first data structure 2021 in the list of data structures for users/user-groups pointed by the UG_List_Pointer 2211 is a data structure for the user C. This user/user-group data structure 2021 has fields containing:
i. A user/user-group identifier 2091 which identifies the user C;
ii. An address pointer Next_U_Pointer 2101 which points to the next user structure in the list of user structures;
iii. An address pointer U_States_Pointer 2111 which points to a list of data structures for the states of the user C and the corresponding permissions for the file identified by the file structure 2191.
   The first data structure 2031 in the list of data structures for the user/user-group states pointed by the U_States_Pointer 2111 is for the state C1 of the User C. This user/user-group state data structure 2031 has fields containing:
i. A user/user-group state 2121 which identifies the user state C1;
ii. The file permissions 2071 which may be assigned to the processes owned by the user C when the user C is in the state C1 depending on the Application Security Environment entries 2221 in the file configuration and the Application Security Environment states of those processes;
iii. An address pointer Next_Pointer 2131 which points to the next user/user-group state data structure in the list.
   The next data structure 2032 in the list of data structures for user/user-group states pointed by the Next_Pointer 2131 is for the state C2 of the user C. This user/user-group state data structure 2032 has fields containing:
i. A user/user-group state 2122 which identifies the user state C2;
ii. The file permissions 2072 which may be assigned to the processes owned by the user C when the user C is in the state C2 depending on the Application Security Environment entries 2221 in the file configuration and the Application Security Environment states of those processes;
iii. An address pointer Next_Pointer 2132 which points to the next user/user-group state data structure in the list. The data structure corresponding to the state C2 is the last data structure in the list and hence, the Next_Pointer 2132 contains an invalid pointer (NULL) value.
   The second data structure 2022 in the list of data structures for users/user-groups pointed by the Next_U_Pointer 2101 is a data structure for Others. This user/user-group data structure 2022 has fields containing:
i. A user/user-group identifier 2092 which identifies the user/user-group Others; Others is the same as the default user/user-group; Others in this case represents all the users and the user-groups other than the user C;
ii. An address pointer Next_U_Pointer 2102 which points to the next user/user-group data structure in the list of user/user-group data structures; The Next_U_Pointer 2102 contains an invalid pointer (NULL) value as the data structure corresponding to Others is the last data structure in the list;
iii. An address pointer U_States_Pointer 2112 which points to a list of data structures for states of the user/user-group Others and the corresponding permissions for the file identified by the file structure 2191; The only state supported for Others is the default state.
   The first data structure 2033 in the list of data structures for user/user-group states pointed by the U_States_Pointer 2112 is for the default state of the user/user-group Others. This user/user-group state data structure 2033 has fields containing:
i. a user/user-group state 2123 which identifies the default user/user-group state; The default state in this case represents all user/user-group states other than user/user-group states C1 and C2;
ii. The file permissions 2073 which may be assigned to the processes owned by the users/user-groups other than when the user C is in the state C1 or C2 depending on the Application Security Environment entries 2221 in the file configuration and the Application Security Environment states of those processes;
iii. An address pointer Next_Pointer 2133 which points to the next user/user-group state data structure in the list. As the data structure corresponding to the default state is the last data structure in the list, the Next_Pointer 2133 contains an invalid pointer (NULL) value.
   The first data structure 2041 in the list of data structures for Application Security Environments pointed by the ASE_List_Pointer 2221 is a data structure for the Application Security Environment Q. This Application Security Environment data structure 2041 has fields containing:
i. An Application Security Environment identifier 2141 which identifies the Application Security Environment Q;
ii. An address pointer Next_A_Pointer 2151 which points to the next Application Security Environment data structure in the list of the Application Security Environment data structures; The data structure corresponding to the Application Security Environment Q is the last data structure in the list and hence, the Next_A_Pointer 2151 contains an invalid pointer (NULL) value;
iii. An address pointer A_States_Pointer 2161 which points to a list of data structures for Application Security Environment states for the Application Security Environment Q and the corresponding permissions for the file identified by the file structure 2191.
   The first data structure 2051 in the list of data structures for Application Security Environment states pointed by the A_States_Pointer 2161 is for the state Q1 of the Application Security Environment Q. This Application Security Environment state data structure 2051 has fields containing:
i. An Application Security Environment state 2171 which identifies the Application Security Environment state Q1;
ii. The file permissions 2074 which are assigned to the processes in the Application Security Environment Q when the Application Security Environment Q is in the state Q1;
iii. An address pointer Next_Pointer 2181 which points to the next Application Security Environment state data structure in the list.
   The next structure 2052 in the list of data structures for Application Security Environment states pointed by the Next_Pointer 2181 points to the data structure for state Q2 of the Application Security Environment Q. This Application Security Environment state data structure 2052 has fields containing:
i. an Application Security Environment state 2172 which identifies the Application Security Environment state Q2;
ii. The file permissions 2075 which are assigned to the processes in the Application Security Environment Q when the Application Security Environment Q is in the state Q2;
iii. An address pointer Next_Pointer 2182 which points to the next Application Security Environment state data structure in the list.
   The next data structure 2053 in the list of data structures for Application Security Environment states pointed by the Next_Pointer 2182 points to the data structure for the default state 2173 of the Application Security Environment Q. This Application Security Environment state data structure 2053 has fields containing:
i. An Application Security Environment state 2173 which identifies the default state of the Application Security Environment Q; The default state in this case includes all the states of the Application Security Environment Q other than the states Q1 2171 and Q2 2172;
ii. The file permissions 2076 which are assigned to the processes owned by the Application Security Environment Q when the Application Security Environment Q is not in the state Q1 or Q2;
iii. An address pointer Next_Pointer 2183 which points to the next Application Security Environment state data structure in the list; The data structure corresponding to the default state is the last data structure in the list and hence, the Next_Pointer 2183 contains an invalid (NULL) pointer value.

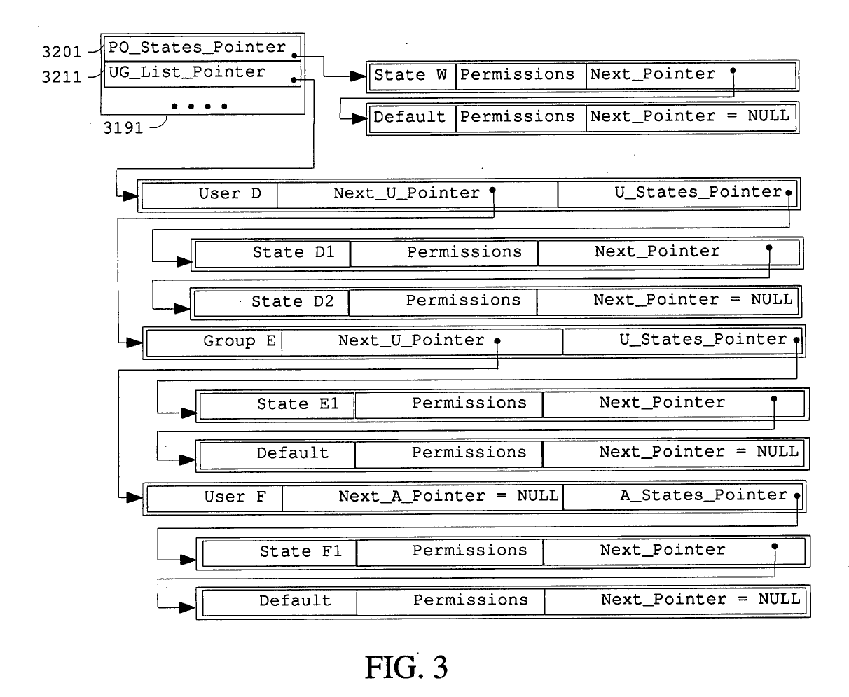

FIG. 3 illustrates an example for data structures which allow the file permissions to change dynamically based on the privilege object state and the user and/or user-group states. The file structure 3191 contains two address pointers, PO_States_Pointer 3201 and UG_List_Pointer 3211. The file system in example uses a global file system privilege object and hence, the privilege object identifier is not part of each file. The PO_States_Pointer 3201 points to a list of data structures containing privilege object states and the corresponding permissions for the file identified by the file structure 3191. The UG_List_Pointer 3211 points to a list of data structures for users and/or user-groups. The data structures containing privilege object states and users/user-groups are similar to the corresponding data structures in FIG. 1.

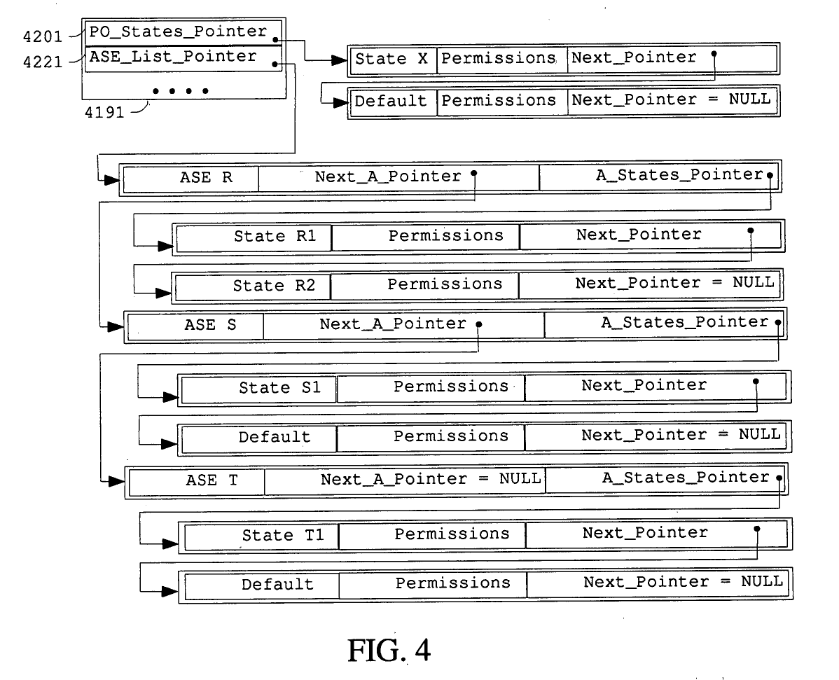

FIG. 4 illustrates an example for data structures which allow the directory permissions to change dynamically based on the privilege object state and the Application Security Environment States. The directory structure 4191 contains two address pointers, PO_States_Pointer 4201 and ASE_List_Pointer 4221. The file system in example uses a global file system privilege object and hence, the privilege object identifier is not part of each file. The PO_States_Pointer 4201 points to a list of data structures containing privilege object states and the corresponding permissions for the directory identified by the directory structure 4191. The ASE_List_Pointer 4221 points to a list of data structures for Application Security Environments. The data structures containing the privilege object states and the Application Security Environments are similar to the corresponding data structures in FIG. 1.

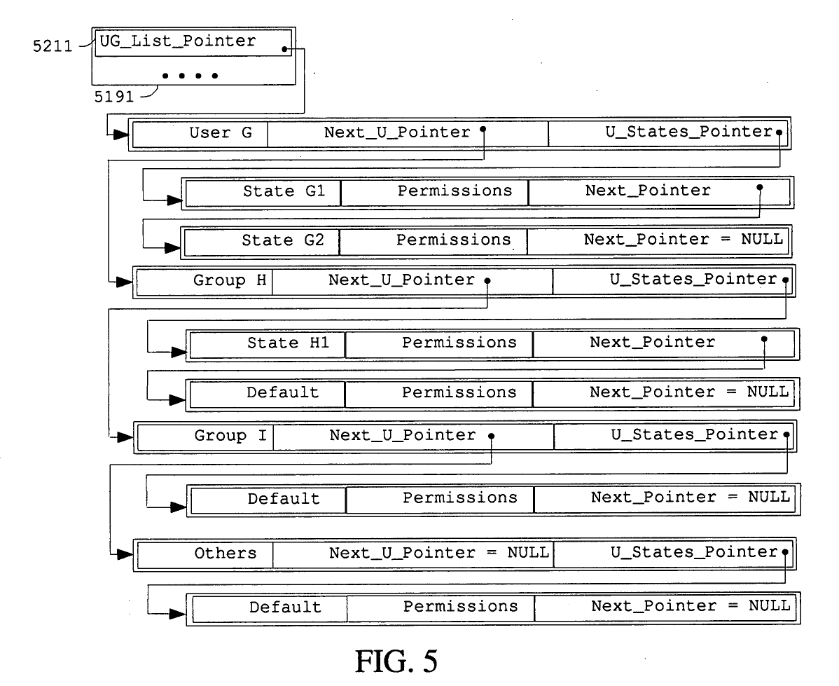

FIG. 5 illustrates an example for data structures which allow the file permissions to change dynamically based on the user and/or user-group states. The file structure 5191 contains one address pointer UG_List_Pointer 5211. The UG_List_Pointer 5211 points to a list of data structures for users and/or user-groups. The data structures containing users/user-groups are similar to the corresponding data structures in FIG. 1.

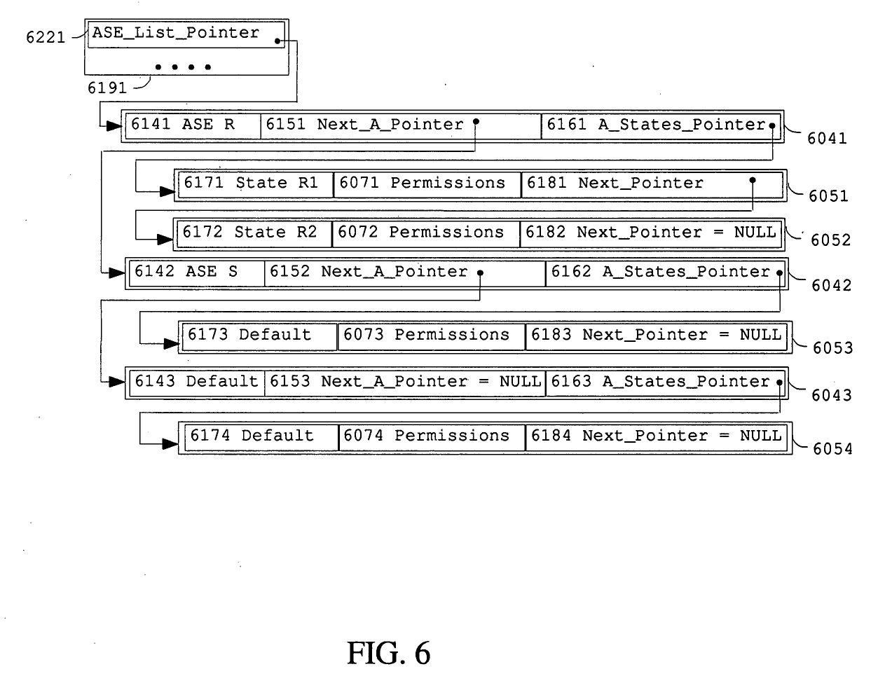

FIG. 6 illustrates an example for data structures which allow the file permissions to change dynamically based on the Application Security Environment states. The file structure 6191 contains one address pointer ASE_List_Pointer 6221. The ASE_List_Pointer 6221 points to a list of data structures for Application Security Environments. The first data structure 6041 in the list of data structures for the Application Security Environments pointed by the address pointer ASE_List_Pointer 6221 is a data structure for the Application Security Environment R. This Application Security Environment data structure 6041 has fields containing:
i. An Application Security Environment identifier 6141 which identifies the Application Security Environment R;
ii. An address pointer Next_A_Pointer 6151 which points to the next Application Security Environment data structure in the list of the Application Security Environment data structures;
iii. An address pointer A_States_Pointer 6161 which points to a list of data structures for the Application Security Environment states of the Application Security Environment R and the corresponding permissions for the file identified by the file structure 6191.
   The first data structure 6051 in the list of data structures for Application Security Environment states pointed by the address pointer A_States_Pointer 6161 is for the state R1 of the Application Security Environment R. This Application Security Environment state data structure 6051 has fields containing:
i. An Application Security Environment state 6171 which identifies the Application Security Environment state R1;
ii. The file permissions 6071 which are assigned to the processes in the Application Security Environment R when the Application Security Environment R is in the state R1;
iii. An address pointer Next_Pointer 6181 which points to the next Application Security Environment state data structure in the list.
   The next data structure 6052 in the list of data structures for Application Security Environment states pointed by the address pointer Next_Pointer 6181 points to the data structure for the state R2 6172 of the Application Security Environment R. This Application Security Environment state data structure 6052 has fields containing:
i. An Application Security Environment state 6172 which identifies the state R2 of the Application Security Environment R;
ii. The file permissions 6072 which are assigned to the processes owned by the Application Security Environment R when the Application Security Environment R is in the state R2;
iii. An address pointer Next_Pointer 6182 which points to the next Application Security Environment state data structure in the list. The data structure corresponding to the state R2 is the last data structure in the list and hence, the address pointer Next_Pointer 6182 contains an invalid pointer (NULL) value.
   The second data structure 6042 in the list of data structures for the Application Security Environments pointed by the address pointer Next_A_Pointer 6151 is a data structure for the Application Security Environment S. This Application Security Environment data structure 6042 has fields containing:
i. An Application Security Environment identifier 6142 which identifies the Application Security Environment S;
ii. An address pointer Next_A_Pointer 6152 which points to the next Application Security Environment data structure in the list of the Application Security Environment data structures;
iii. An address pointer A_States_Pointer 6162 which points to a list of data structures for Application Security Environment states of the Application Security Environment S and the corresponding permissions for the file identified by the file structure 6191.
   The first data structure 6053 in the list of data structures for the Application Security Environment states pointed by the address pointer A_States_Pointer 6162 is for the default state of the Application Security Environment S. This Application Security Environment state data structure 6053 has fields containing:
i. An Application Security Environment state 6173 which identifies the default state of the Application Security Environment S; The default state in this case represents all the states of the Application Security Environment S;
ii. The file permissions 6073 which are assigned to the processes in the Application Security Environment S;
iii. An address pointer Next_Pointer 6183 which points to the next Application Security Environment state data structure in the list. The data structure corresponding to the default state is the last data structure in the list and hence, the address pointer Next_Pointer 6183 contains an invalid pointer (NULL) value.
   The third data structure 6043 in the list of data structures for the Application Security Environments pointed by the address pointer Next_A_Pointer 6152 is a data structure for the default Application Security Environment. This Application Security Environment data structure 6043 has fields containing:
i. An Application Security Environment identifier 6143 which identifies the default Application Security Environment;
ii. An address pointer Next_A_Pointer 6153 which points to the next Application Security Environment data structure in the list of the Application Security Environment data structures; The data structure corresponding to the default Application Security Environment is the last data structure in the list and hence, the address pointer Next_A_Pointer 6153 contains an invalid pointer (NULL) value.
iii. An address pointer A_States_Pointer 6163 which points to a list of data structures for the states of the default Application Security Environment and the corresponding permissions for the file identified by the file structure 6191. Only the default state is supported for the default Application Security Environment;
   The first data structure 6054 in the list of data structures for Application Security Environment states pointed by the address pointer A_States_Pointer 6163 is for the default state of the default Application Security Environment. This Application Security Environment state data structure 6054 has fields containing:
i. An Application Security Environment state 6174 which identifies the default state of the default Application Security Environment; The default state in this case represents the states of the Application Security Environments other than all the states of the Application Security Environment S and the states R1 and R2 of the Application Security Environment R;
ii. The file permissions 6074 which are assigned to the processes in the Application Security Environments corresponding to the default state of the default Application Security Environment;
iii. An address pointer Next_Pointer 6184 which points to the next Application Security Environment state data structure in the list. The data structure corresponding to the default state is the last data structure in the list and hence, the address pointer Next_Pointer 6184 contains an invalid pointer (NULL) value.

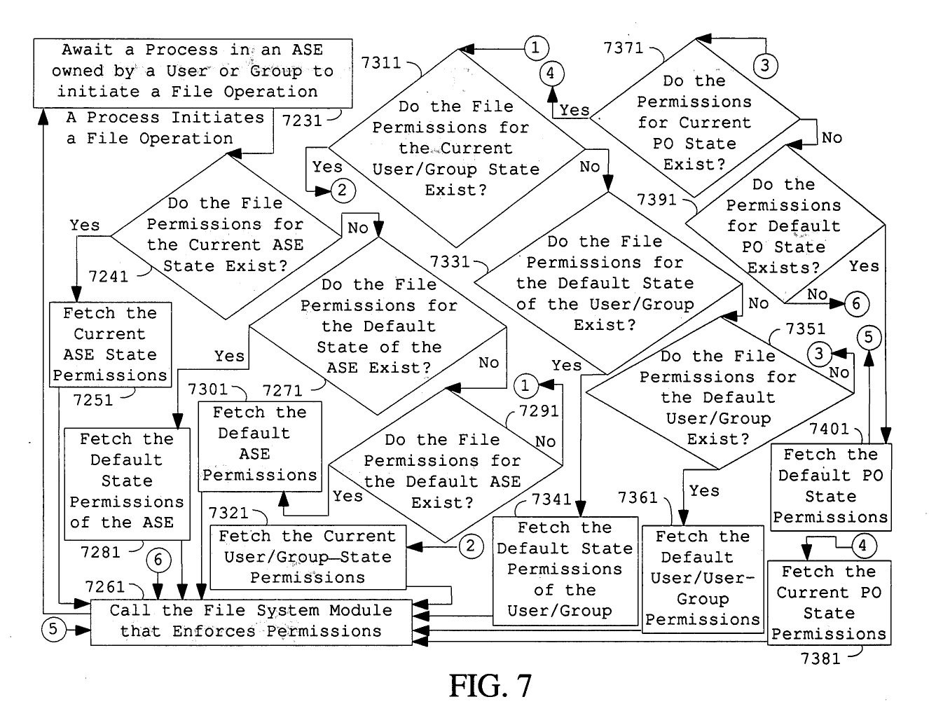

FIG. 7 illustrates an example of a state machine that can be used by the file systems for selecting the correct set of permissions which can be used to allow or not allow a file operation requested by a process to proceed based on:
i. The current state of the Application Security Environment in which that process is running;
ii. The current state of the user/user-group who owns that process or the Application Security Environment in which that process is running;
iii. The current state of the privilege object which represents that file.

In FIG. 7, the state machine is initially in a state 7231 in which it awaits the next file operation from a process. When a process performs a file operation, the state machine changes to a state 7241 in which the file structure is searched to check whether any file permissions are configured for the current state of the Application Security Environment in which the process which requested the file operation is running. If file permissions are configured for the current Application Security Environment state then those permissions are fetched 7251 and the module that enforces the file system permissions is invoked 7261 by passing those permissions and the file operation requested by the process as parameters. The state machine will return to its initial state 7231 after invoking the module that enforces the file system permissions. If permissions are not configured for the current Application Security Environment state then the state machine changes to a state 7271 in which the file structure is searched to check whether any file permissions are configured for the default state of the Application Security Environment in which the process which requested the file operation is running. If file permissions are configured for the default state of the Application Security Environment then those permissions are fetched 7281 and the module that enforces the file system permissions is invoked 7261 by passing those permissions and the file operation requested by the process as parameters. The state machine will return to its initial state 7231 after invoking the module that enforces the file system permissions. If permissions are not configured for the default state of the Application Security Environment then the state machine changes to a state 7291 in which the file structure is searched to check whether any file permissions are configured for the default Application Security Environment. If file permissions are configured for the default Application Security Environment then those permissions are fetched 7301 and the module that enforces the file system permissions is invoked 7261 by passing those permissions and the file operation requested by the process as parameters. The state machine will return to its initial state 7231 after invoking the module that enforces the file system permissions. If permissions are not configured for the default Application Security Environment then the state machine changes to a state 7311 in which the file structure is searched to check whether any file permissions are configured for the current state of the user or the user-group who owns the process which requested the file operation. If file permissions are configured for the current user or user-group state then those permissions are fetched 7321 and the module that enforces the file system permissions is invoked 7261 by passing those permissions and the file operation requested by the process as parameters. The state machine will return to its initial state 7231 after invoking the module that enforces the file system permissions. If permissions are not configured for the current user or user-group state then the state machine changes to a state 7331 in which the file structure is searched to check whether any file permissions are configured for the default state of the user or the user-group who owns the process which requested the file operation. If file permissions are configured for the default state of the user or the user-group then those permissions are fetched 7341 and the module that enforces the file system permissions is invoked 7261 by passing those permissions and the file operation requested by the process as parameters. The state machine will return to its initial state 7231 after invoking the module that enforces the file system permissions. If permissions are not configured for the default state of the user or user-group then the state machine changes to a state 7351 in which the file structure is searched to check whether any file permissions are configured for the default user or the user-group. If file permissions are configured for the default user or user-group then those permissions are fetched 7361 and the module that enforces the file system permissions is invoked 7261 by passing those permissions and the file operation requested by the process as parameters. The state machine will return to its initial state 7231 after invoking the module that enforces the file system permissions. If permissions are not configured for the default user or user-group then the state machine changes to a state 7371 in which the file structure is searched to check whether any file permissions are configured for the current privilege object state. If file permissions are configured for the current privilege object state then those permissions are fetched 7381 and the module that enforces the file system permissions is invoked 7261 by passing those permissions and the file operation requested by the process as parameters. The state machine will return to its initial state 7231 after invoking the module that enforces the file system permissions. If permissions are not configured for the current privilege object state then the state machine changes to a state 7391 in which the file structure is searched to check whether any file permissions are configured for the default state of the privilege object. If file permissions are configured for the default state of the privilege object then those permissions are fetched 7401 and the module that enforces the file system permissions is invoked 7261 by passing those permissions and the file operation requested by the process as parameters. The state machine will return to its initial state 7231 after invoking the module that enforces the file system permissions. If permissions are not configured for the default state of the privilege object then the module that enforces the file system permissions is invoked 7261 by passing empty (NULL) permissions and the file operation requested by the process as parameters. The state machine will return to its initial state 7231 after invoking the module that enforces the file system permissions.

The module that enforces the file system permissions may allow or not allow the file operation to proceed based on the permissions. If the file operation is not allowed to proceed, an error is returned to the process that initiated the file operation. Preferably, the module that enforces the file system permissions will fail the file operations if the permission data structure is empty. Optionally, the module that enforces the file system permissions will allow the file operations if the permission data structure is empty.

Similar state machines can be used for directory operations also.

Optionally, checking the permissions need to be done only for the file open operation and the rest of the operations to the file can be allowed based on the permissions at the file open time.

The same state machine will work even when permissions based on one or more of the Application Security Environment states or the user/user-group states or the privilege object states are not used. For example, if a file system does not support current/default user states, the check for permissions corresponding to current/default user states will always fail and those failures are handled by the state machine. However, if those states are not used in a file system, the state machine can be optimized by removing the corresponding states.

We recommend the usage of default Application Security Environment only if there are no user/user-group state or privilege object state based permissions. Similarly, we recommend the usage of default user or user-group only if there are no privilege object state based permissions. When the default Application Security Environment or the default user/user-group are not supported, the state machine can be optimized by removing the corresponding states.

The state machine in FIG. 7 supports only the default state for the default Application Security Environment. The user or user-group state based permissions which are supported by that state machine give more flexibility than supporting multiple states for default Application Security Environments. Some implementations may allow multiple states to be defined for the default Application Security Environments. Similarly, the state machine in FIG. 7 supports only the default state for the default user/user-group. However, the privilege object state based permissions which are supported by that state machine give same amount of flexibility as supporting multiple states for the default users/user-groups. Some implementations may allow multiple states to be defined for default users/user-groups.

The privilege object state can be mapped to the state of any one or more of the modules running in the operating system. A privilege object state can be mapped to the state of the operating system or to the state of the computer partition in which the operating system is running or to the state of the computer in which the operating system is running or to the state of a device attached to the computer. When more than one privilege objects are used to control permissions to an object then preferably, priority between those modules must be used to select the correct permissions to be used. As illustrated in FIG. 7, a privilege object can be given higher priority by checking the state of that privilege object before checking the state of other privilege objects by a state machine. When more than one privilege objects are used to control permissions to an object then optionally, the permissions can be obtained by performing AND or OR operation on permissions corresponding the current states of those privilege objects. When more than one privilege object is used to control permissions to an object then optionally, a combination of priority between privilege objects and AND operation on permissions and OR operation on permissions can be used to obtain the permissions to be used. Similar AND or OR operation can be performed with permissions corresponding to the current state of the user or the user-group, the permissions corresponding to the current state of the Application Security Environment and the permissions corresponding to the current state of the privilege objects. When a combination of priority, AND operation and OR operation is used, additional bits can be added to permissions or the structure containing permissions which specify the operation (AND/OR) to be done. We recommend that only one privilege object should be used for each object or for each group of objects so that complexity in implementations is reduced.

The pointers shown in the examples FIG. 1 to FIG. 6 must be converted to indexes into arrays of data structures when those data structures are copied to mass-memories (storage disks). It is recommended that the group of data structures containing the lists of permissions for files in each directory must be stored together in the mass-memory to improve access times to fetch permissions of files in a directory. This type of conversion and storage is normally used for storing kernel data structures containing kernel configurations in mass-memories.

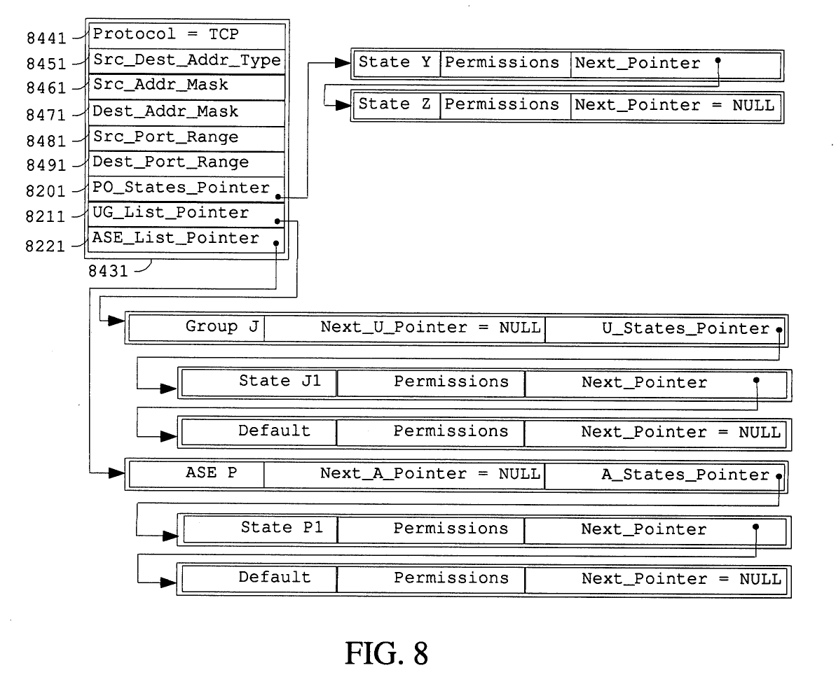

FIG. 8 illustrates an example of data structures that can be used for controlling incoming and/or outgoing network connections based on states by a networking stack. Preferably, such controls must be implemented in the Network layer (layer 3) or the Transport layer (layer 4) or the layers above the Network layer or the Transport layer. The data structure 8431 contains details of the connections to be blocked or allowed based on the states and three address pointers, PO_States_Pointer 8201, UG_List_Pointer 8211 and ASE_List_Pointer 8221. The networking stack in example uses a global privilege object and hence, the privilege object identifier is not part of each structure. The PO_States_Pointer 8201 points to a list of data structures containing privilege object states and the corresponding permissions for the network connections identified by the data structure 8431. The UG_List_Pointer 8211 points to a list of data structures for users and/or user-groups. The ASE_List_Pointer 8221 points to a list of data structures for Application Security Environments. The data structures containing the privilege object states, the users/user-groups and the Application Security Environments are similar to the corresponding data structures in FIG. 1. However, the permissions in this case indicate whether the connections identified by the data structure 8431 are allowed or not. The protocol field 8441 in the data structure 8431 identifies the protocol as TCP. The field Src_Dest_Addr_Type 8451 indicates whether a network (IP) address or a network (IP) address mask is configured for source and destination. This field 8451 allows none or one or both the network address fields to be configured as network address masks. The field Src_Addr_Mask 8461 will either contain a network address or a network address mask for the local node/system. The field Dest_Addr_Mask 8471 will either contain a network address or a network address mask for the remote node/system. The field Src_Port_Range 8481 will identify a range of local ports (TCP ports). The field Dest_Port_Range 8491 will identify a range of remote ports (TCP ports). Since every TCP connection can be identified using a local address, a remote address, a local port and a remote port, this data structure is sufficient to completely identify one or more TCP connections. The data structure 8431 can be used for controlling the list of applications and/or users who can initiate a set of network services or initiate a set of outgoing network connections.

Since the states of an Application Security Environment or a user/user-group or a privilege object can control both file permissions and network connections, this invention can be used for blocking new network connections when read/write access to critical files are enabled. This method can also be used to disable active connections when the state changes. In this case, the permission is checked for every incoming or outgoing data packet instead of checking for every incoming or outgoing connection. We recommend that permissions must not impact the closing of an open connection to prevent processes from hanging.

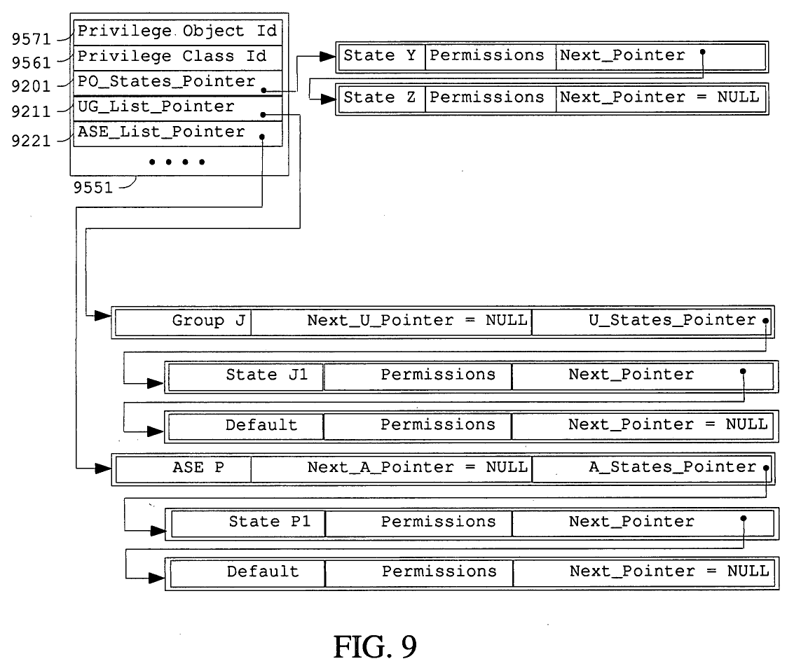

FIG. 9 illustrates an example of data structures that can be used for controlling the execution of privileged operations by the operating system based on states. The data structure 9551 contains an identifier 9561 for the class of privileged operations to be blocked or allowed based on the states, a privilege object identifier 9571 which is used for getting the current state of the privilege object and three address pointers, PO_States_Pointer 9201, UG_List_Pointer 9211 and ASE_List_Pointer 9221. The PO_States_Pointer 9201 points to a list of data structures containing privilege object states and the corresponding permissions to the privileged operation identified by the data structure 9551. The UG_List_Pointer 9211 points to a list of data structures for users and/or user-groups. The ASE_List_Pointer 9221 points to a list of data structures for Application Security Environments. The data structures containing the privilege object states, the users/user-groups and the Application Security Environments are similar to the corresponding data structures in FIG. 1. However, the permissions in this case indicate whether the privileged operations identified by the identifier 9561 are allowed or not.

A set of privileged operations could also be identified using a mask instead of using a class identifier. This technology can be used for controlling the access to any object including permission data structures of one or more objects.

A software or one or more devices can be used to change the states dynamically. The software which allows states to be changed dynamically should support one or more Application Security Environments and/or one or more users and/or one or more user-groups and/or one or more privilege objects. This software should also support none or one or more states for each supported Application Security Environment, for each supported user, for each supported user-group and for each supported privilege object such that these states can be used for controlling permissions for performing operations on different objects in the operating system or for controlling access to the devices attached to the computer. Preferably, this software supports user authentication and state changes can be done only by an authenticated user. The device which allows states to be changed dynamically should support one or more Application Security Environments and/or one or more users and/or one or more user-groups and/or one or more privilege objects and/or none or one or more device states. This device should support none or one or more states for each Application Security Environment, for each supported user, for each supported user-group and for each supported privilege object such that these states can be used for controlling permissions for performing operations on different objects in the operating system or for controlling access to the devices attached to the computer. Preferably, the state change can be done only by an authenticated user by performing a manual action on the device or the state change can be completed only after the user performing the manual action for the state change is authenticated.

This invention will allow file permissions to be enabled only when a user needs to run processes that require those permissions. As the privilege object states and/or the user/user-group states and/or the Application Security Environment states can be controlled by devices external to the computer, this can significantly improve security.

This technology will allow users to dynamically enable and disable file and network permissions for themselves and for the applications owned by themselves even when they do not have write access to the corresponding file/network permission data structures. This will significantly improve security as users can dynamically enable and disable permissions to objects in a computer on a need basis even when they do not have write access to the permission data structures of the corresponding objects.

What is claimed is:

1. A method of controlling file and/or directory operations and/or controlling network connections from a process or task running in an Application Security Environment (where an Application Security Environment is an environment in which one or more processes or tasks can be run and the privileges of the processes or tasks in the Application Security Environment can be a subset of the privileges of the user or the user-group who owns that Application Security Environment) which is owned by a user or a user-group (where a user-group is a group of users) based on:
i. The current state of that Application Security Environment and/or
ii. The current state of that user or user-group who owns that Application Security Environment and/or
iii. The current state of one or more privilege objects. A privilege object has one or more states such that these states can be mapped to permissions which processes or tasks have to perform operations on one or more objects.

2. A method of controlling file and/or directory operations and/or controlling network connections from a process or task which is owned by a user or a user-group based on:
i. The current state of that user or user-group and/or
ii. The current state of one or more privilege objects.

3. When the states of the privilege objects and/or the state of the user or user-group and/or the state of the Application Security Environment are used to control the permissions which a process or a task has to perform an operation on an object as claimed in (1) then:
i. Preferably, the selection of the permissions should be based on the priority of those privilege objects and/or that user or user-group and/or that Application Security Environment.
ii. Optionally, the permissions can be obtained by performing AND or OR operations on the permissions corresponding to the current states of those privilege objects and/or that user or user-group and/or that Application Security Environment.
iii. Optionally, the permissions can be obtained by using a combination of:
a. The priority between privilege objects and/or that user or user-group and/or that Application Security Environment, and
b. Performing AND or OR operations on the permissions corresponding to the current states of those privilege objects and/or that user or user-group and/or that Application Security Environment.

4. When the states of the privilege objects and/or the state of the user or user-group are used to control the permissions which a process or a task has to perform an operation on an object as claimed in (2) then:
i. Preferably, the selection of the permissions should be based on the priority of those privilege objects and/or that user or user-group.
ii. Optionally, the permissions can be obtained by performing AND or OR operations on the permissions corresponding to the current states of those privilege objects and/or that user or user-group.
iii. Optionally, the permissions can be obtained by using a combination of:
a. The priority between privilege objects and/or that user or user-group, and
b. Performing AND or OR operations on the permissions corresponding to the current states of those privilege objects and/or that user or user-group.

5. The privileges of a user or a user-group or an Application Security Environment can be changed dynamically by changing the states as claimed in (1) even when the user or the user-group does-not have write access to the corresponding permission data structures.

6. The modules in the operating system such as file systems and networking stacks being capable of detecting states of claim (1).

7. A software which allows the states of claim (1) to be controlled dynamically. This software supporting one or more Application Security Environments and/or one or more users and/or one or more user-groups and/or one or more privilege objects. This software supporting none or one or more states for each supported Application Security Environment, for each supported user, for each supported user-group and for each supported privilege object such that these states can be used for controlling permissions which processes or tasks have to perform operations on different objects in the operating system and/or permissions for controlling access to the devices attached to the computer. Preferably, this software allows only an authenticated user to make state changes.

8. Optionally, privilege object states of claim (1) can be mapped to the states of the operating system and/or the computer partition and/or the computer and/or one or more devices attached to the computer;

9. A device which allows the states of claim (1) to be controlled. This device supporting one or more users and/or one or more user-groups and/or one or more Application Security Environments and/or one or more privilege objects. This device supporting none or one state for one or more supported users, none or one or more states for each supported user-group and none or one or more states for each supported privilege object such that these states can be used for controlling permissions which processes or tasks have to perform operations on different objects in the operating system and/or permissions for controlling access to the devices attached to the computer.

10. Preferably, the state change can be done only by an authenticated user by performing a manual action on the device of claim (9) or the state change can be completed only after the user performing the manual action on the device of claim (9) for the state change is authenticated. The mechanism used by the device for authenticating a user who performed a manual action to change the state on that device may be based on finger print and/or retina and/or password and/or user name and/or other current or future technologies for user authentication. The manual action for performing a state change may be pressing one or more buttons and/or toggling the position of one or more switches and/or turning a wheel and/or changing one or more jumper positions and/or any other manual action accepted by the device.

11. Preferably, the state change can be done only by an authenticated user by performing a manual action on a device which directly or indirectly controls state changes on the device of claim (9) or the state change can be completed only after the user performing the manual action for the state change on a device which directly or indirectly controls state changes on the device of claim (9) is authenticated.

12. The modules in the operating system such as file systems and networking stacks being capable of detecting states of claim (2).

13. A software which allows the states of claim (2) to be controlled dynamically. This software supporting one or more users and/or one or more user-groups and/or one or more privilege objects. This software supporting none or one or more states for each supported user, for each supported user-group and for each supported privilege object such that these states can be used for controlling permissions which processes or tasks have to perform operations on different objects in the operating system and/or permissions for controlling access to the devices attached to the computer. Preferably, this software allows only an authenticated user to make state changes.

14. A device which allows the states of claim (2) to be controlled. This device supporting one or more users and/or one or more user-groups and/or one or more privilege objects. This device supporting none or one state for one or more supported users, none or one or more states for each supported user-group and none or one or more states for each supported privilege object such that these states can be used for controlling permissions which processes or tasks have to perform operations on different objects in the operating system and/or permissions for controlling access to the devices attached to the computer.

15. Preferably, the state change can be done only by an authenticated user by performing a manual action on the device of claim (14) or the state change can be completed only after the user performing the manual action on the device of claim (14) for the state change is authenticated.

16. Preferably, the state change can be done only by an authenticated user by performing a manual action on a device which directly or indirectly controls state changes on the device of claim (14) or the state change can be completed only after the user performing the manual action for the state change on a device which directly or indirectly controls state changes on the device of claim (14) is authenticated.

17. A device supporting one or more users and/or one or more user-groups and/or one or more privilege objects. This device supporting none or one state for one or more supported users, none or one or more states for each supported user-group and none or one or more states for each supported privilege object such that these states can be used for controlling permissions which processes or tasks have to perform operations on different objects in the operating system and/or permissions for controlling access to the devices attached to the computer. Optionally, the privilege object states of the device can be mapped to the states of modules in the operating system and/or the states of the computer partition and/or the states of the computer and/or the states of one or more devices attached to the computer.

18. When the device of claim (17) can support only one privilege object, the selection of a privilege object not being required and the state of the privilege object being the same as the state of the device. This device supporting user authentication.

19. Preferably, the state change can be done only by an authenticated user by performing a manual action on the device of claim (17) or the state change can be completed only after the user performing the manual action on the device of claim (17) for the state change is authenticated.

20. Preferably, the state change can be done only by an authenticated user by performing a manual action on a device which directly or indirectly controls state changes on the device of claim (17) or the state change can be completed only after the user performing the manual action for the state change on a device which directly or indirectly controls state changes on the device of claim (17) is authenticated.

21. Using the Application Security Environment states or user/user-group states or privilege object states of claim (1) for dynamically controlling the permissions to objects such as data structures containing permissions for files or directories in a directory.

22. Using the user/user-group states or privilege object states of claim (2) for dynamically controlling permissions to objects such as data structures containing permissions for files or directories in a directory. Using the user/user-group states or privilege object states of claim (2) for controlling the execution of privileged operations.
